(19) United States
(12) Patent Application Publication
(10) Pub. No.: US 2025/0243322 A1
(43) Pub. Date: Jul. 31, 2025

(54) AMINOPOLYMERS WITH PENDANT HYDROXYL FUNCTIONALITIES

(71) Applicant: Lawrence Livermore National Security, LLC, Livermore, CA (US)

(72) Inventors: Simon Hoching Pang, San Leandro, CA (US); Anthony John Varni, Dublin, CA (US); Lucas Sewall Thigpen, Dublin, CA (US)

(21) Appl. No.: 18/427,568

(22) Filed: Jan. 30, 2024

(51) Int. Cl. C08G 73/02; B01J 20/26

(52) U.S. Cl. CPC C08G 73/0213; B01J 20/262; C08G 73/0206

(57) ABSTRACT

A product, in accordance with one aspect of the present invention, includes an aminopolymer having hydroxyl functional groups coupled directly to carbon atoms in a backbone of the aminopolymer. In another general embodiment, a method of forming an aminopolymer having hydroxyl functional groups coupled directly to carbon atoms in a backbone of the aminopolymer includes polymerizing a monomer having a protected hydroxyl group coupled to a carbon atom of the monomer, thereby creating a first polymer. An aminopolymer with pendant hydroxyl functionalities is created from the first polymer by, at least in part, removing hydroxyl protecting groups of the protected hydroxyl groups of the first polymer.

This invention was made with Government support under Contract No. DE-AC52-07NA27344 awarded by the United States Department of Energy. The Government has certain rights in the invention.

### FIELD OF THE INVENTION

The present invention relates to aminopolymers, and more particularly, this invention relates to aminopolymers with pendant hydroxyl functionalities, and methods of making same.

### BACKGROUND

Solid-supported amine sorbents are a promising class of technology for CO₂ capture. The active material in these sorbents is an amine-dense polymer (aminopolymer), which is impregnated into a highly porous support to increase the aminopolymer's surface area. As illustrated in the schematic drawing in FIG. 1, gas mixtures having ultra-dilute concentrations of CO₂ may flow over a CO₂ chemisorbent, comprising a solid-supported aminopolymer, to which the CO₂ molecules bind.

While this technology has continued to receive increased attention for implementation at the industrial scale, a key remaining challenge is improving the working lifetime of the sorbents. More specifically, the aminopolymers that are responsible for the CO₂ capture mechanism undergo degradation upon exposure to atmosphere, which can be accelerated by the elevated temperatures typically required for sorbent regeneration (i.e., desorption of captured CO₂).

Increasing the stability of these sorbents is therefore critical towards improving the economic viability of the technology.

One strategy that has become increasingly prominent in the literature is the addition of hydroxyl functional groups to the aminopolymer. In prior art, this has been achieved by reaction of the amine functional groups with an epoxide species, which generates the desired hydroxyls through a ring-opening mechanism (i.e. through nucleophilic attack by the amine species on the epoxide), converting the epoxide to a chemically tethered hydroxyl. These hydroxyl functionalized aminopolymers show enhanced oxidative and thermal stability over their unmodified precursors, and also demonstrate desirable properties such as faster CO₂ adsorption kinetics and lower energy requirements for CO₂ desorption.

However, a critical limitation of this approach is that increasing the extent of hydroxyl functionalization inherently decreases the material's CO₂ uptake capacity due to the reaction with the amine. Specifically, with higher extents of functionalization, a larger proportion of amines are converted to tertiary amines, which are significantly less active toward CO₂ capture than primary and secondary amines. As such, developing materials that can retain the demonstrated benefits of hydroxyl functionalization without sacrificing CO₂ capture capacity would be highly desirable.

### SUMMARY

A product, in accordance with one aspect of the present invention, includes an aminopolymer having hydroxyl functional groups coupled directly to carbon atoms in a backbone of the aminopolymer.

A method of forming an aminopolymer having hydroxyl functional groups coupled directly to carbon atoms in a backbone of the aminopolymer, in accordance with one aspect of the present invention, includes polymerizing a monomer having a protected hydroxyl group coupled to a carbon atom of the monomer, thereby creating a first polymer. An aminopolymer with pendant hydroxyl functionalities is created from the first polymer by, at least in part, removing hydroxyl protecting groups of the protected hydroxyl groups of the first polymer.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic drawing of a process using a conventional chemisorbent for CO₂ capture from ambient air (direct air capture).

FIG. 2 depicts a reaction of a branched aminopolymer with an epoxide species resulting hydroxides being coupled to the amine functional groups.

FIG. 3 is a depiction of illustrative repeat units for polyethylenimines and polypropylenimines, as well as illustrative hydroxyl functionalities.

FIG. 4 is a flowchart of a method for forming an aminopolymer having hydroxyl functional groups coupled directly to carbon atoms in the backbone of the aminopolymer, in accordance with various aspects of the present invention.

FIG. 5 depicts an illustrative method for production of a linear poly(ethylenimine) (PEI) with pendant hydroxyls, in accordance with one approach.

FIG. 6 depicts an illustrative method for production of a linear poly(ethylenimine) with pendant hydroxyls, in accordance with one approach.

FIG. 7. depicts an illustrative method for production of branched poly(ethylenimine) with pendant hydroxyls, in accordance with one approach.

FIG. 8 is a stepwise series of drawings depicting formation and use of a porous ceramic support with aminopolymer thereon for CO₂ capture, according to one embodiment. Part (a) represents the formation of a porous ceramic support. Part (b) represents incorporation of an aminopolymer to the porous ceramic support thereby forming a product. Part (c) represents capture of CO₂ from a mixed gas by the product. Part (d) represents regeneration performed on the product.

FIG. 9 depicts an illustrative method for production of a linear PEI with pendant hydroxyls at the carbon adjacent to the amine functionality, beginning from DL-serine, in accordance with an exemplary embodiment.

FIG. 10 depicts synthesis of the hydrogen chloride salt of methyl serinate, in accordance with an exemplary embodiment.

FIG. 11 depicts the synthesis of methyl O-(tert-butyldimethylsilyl) serinate, in accordance with an exemplary embodiment.

FIG. 12 depicts the synthesis of 2-amino-3-((tert-butyldimethylsilyl)oxy) propan-1-ol, in accordance with an exemplary embodiment.

FIG. 13 depicts the synthesis of 4-(((tert-butyldimethylsilyl)oxy)methyl)-2-methyl-4,5-dihydrooxazole, in accordance with an exemplary embodiment.

FIG. 14 is a chart depicting the 1H-NMR spectra for relevant synthesized materials.

FIG. 15 is a depiction of a branched aminopolymer with hydroxyl functional groups, in accordance with an exemplary embodiment.

FIG. 16 is a depiction of a linear aminopolymer with hydroxyl functional groups, in accordance with an exemplary embodiment.

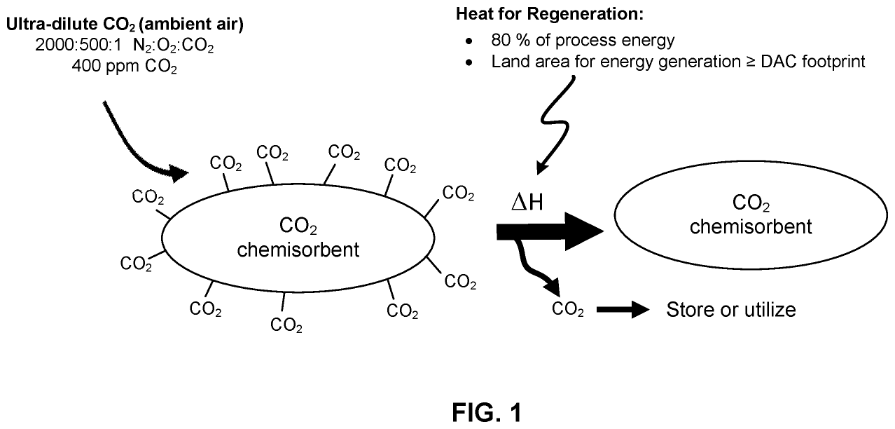

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

It is also noted that, as used in the specification and the appended claims, wt. % is defined as the percentage of weight of a particular component is to the total weight/mass of the mixture. Vol. % is defined as the percentage of volume of a particular compound to the total volume of the mixture or compound. Mol. % is defined as the percentage of moles of a particular component to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of a mixture, an ink, a printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The following description discloses various embodiments of aminopolymers with pendant hydroxyl functionalities and/or related systems and methods. Such aminopolymers are particularly useful as gas sorbents.

In one general embodiment, a product includes an aminopolymer having hydroxyl functional groups coupled directly to carbon atoms in a backbone of the aminopolymer.

In another general embodiment, a method of forming an aminopolymer having hydroxyl functional groups coupled directly to carbon atoms in a backbone of the aminopolymer includes polymerizing a monomer having a protected hydroxyl group coupled to a carbon atom of the monomer, thereby creating a first polymer. An aminopolymer with pendant hydroxyl functionalities is created from the first polymer by, at least in part, removing hydroxyl protecting groups of the protected hydroxyl groups of the first polymer.

As mentioned above, solid-supported amine sorbents are one of the most promising classes of technology for CO₂ capture. The active material in these sorbents is an amine-dense polymer (aminopolymer), which is typically impregnated into a highly porous support to increase the aminopolymer surface area.

While this technology has continued to receive increased attention for implementation at the industrial scale, a key remaining challenge is improving the working lifetime of the sorbents. More specifically, the aminopolymers that are responsible for the CO₂ capture mechanism undergo degradation upon exposure to atmosphere (particularly oxygen), which can be accelerated by the elevated temperatures typically required for sorbent regeneration (i.e., desorption of captured CO₂). For instance, the nitrogen functionalities tend to convert to other functionalities, such as imines, amides, etc. and those sites are then unable to interact with CO₂.

Increasing the stability of these sorbents is therefore critical for improving the economic viability of the technology. To achieve this goal, one strategy that has appeared in the literature is the addition of hydroxyl functional groups to the aminopolymer.

Aminopolymers modified with hydroxyl functional groups have recently shown tremendous potential for use in CO₂ capture sorbents due to their improved oxidative stabilities over the unmodified precursors as well as lower energy requirements for regeneration (i.e., CO₂ desorption).

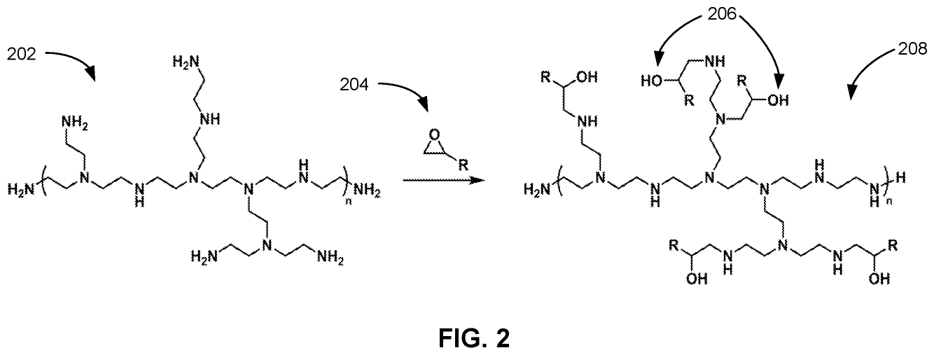

As shown in FIG. 2, The literature-reported method of introducing a hydroxyl functional group to an aminopolymer is to react amine functional groups of a branched aminopolymer 202 with an epoxide species 204, which generates the desired hydroxyls through a ring-opening mechanism (i.e. through nucleophilic attack by the amine species on the epoxide), converting the epoxide to a chemically tethered hydroxyl 206. Note that to date, it appears that all prior work has added hydroxyl groups to the amine functional groups of branched aminopolymers; no prior attempts to perform the reaction of FIG. 2 or the like with linear aminopolymers in the literature are presently known, although oligoamines have been explored.

Referring again to FIG. 2, the hydroxyl functionalized aminopolymers 208 show enhanced oxidative and thermal stability over their unmodified precursors (e.g., branched aminopolymer 202), and also demonstrate desirable properties such as faster CO₂ adsorption kinetics and lower energy requirements for CO₂ desorption. The improved stability has primarily been attributed to hydrogen bonding interactions between the hydroxyl and amine functional groups.

However, a critical limitation of this prior approach is that these materials show decreased CO₂ uptake capacities due to the reaction with the amine. Particularly, the extent of hydroxyl functionalization inherently decreases the CO₂ uptake capacity of the material due to the reaction with the amine. Without wishing to be bound by any particular theory, it is presently believed that with higher extents of functionalization, a larger proportion of amines are converted to tertiary amines, which are significantly less active toward CO₂ capture than primary and secondary amines. As such, with approaches such as that shown in FIG. 2, it is impossible to achieve high hydroxyl to amine ratios without effectively eliminating the material's CO₂ uptake capacity.

Various aspects of the present invention described herein overcome the drawback noted immediately above by providing a new, alternative polymer design strategy to target hydroxyl functionalized aminopolymers with comparable CO₂ uptake capacities to unmodified aminopolymer structures, as well as the improved oxidative and thermal stability imparted by the hydroxyl groups. Also presented herein are synthetic approaches to producing materials in which the hydroxyl groups are tethered to a carbon atom in the backbone of the polymer structural repeat unit, rather than the amine.

In doing so, materials containing a more desirable ratio of hydroxyls to amines can be synthesized while retaining the same distribution of amine functionalities (primary, secondary, and tertiary amines) as the unmodified polymeric structure. Therefore, the inventive approaches presented herein result in aminopolymers that should maximize the protective effect of hydroxyl groups toward oxidative degradation without sacrificing CO₂ uptake capacity.

A product, in accordance with one general approach, includes an aminopolymer having hydroxyl functional groups coupled directly to carbon atoms in a backbone of the aminopolymer. A hydroxyl functional group 302, as described herein, may include a single hydroxyl group (—OH) or may include a tethering group with a hydroxyl group (—OH) on the tethering group. Note also that the tethering groups may be carbon chains, various isomers, etc. Preferably, the aminopolymer has no or essentially no hydroxyl functional groups coupled to amine groups of the polymer.

In some aspects, the aminopolymer is a linear polymer.

In other aspects, the aminopolymer is a branched polymer.

In preferred approaches, the aminopolymer is selected from the group consisting of: poly(alkylamine), poly(ethylenimine), poly(propylenimine), poly(vinylamine), poly(allylamine), and a combination thereof. Particularly preferred aminopolymers are poly(ethylenimine) (PEI) and poly(propylenimine) (PPI) derivatives with hydroxyl functionalities tethered to at least one of the carbon atoms of the polymer backbone. In preferred approaches, the aminopolymer has no benzene group therein. Typically, the distal end groups of the aminopolymers are amine groups, but may have other structure(s) in some approaches.

The aminopolymer may have an average molecular weight in a range of about 350 grams per mol to about 100000 grams per mol, though some approaches may have higher or lower average molecular weights, e.g., in a range of about 1000 to about 50000 grams per mol. In preferred approaches, the aminopolymer has an average molecular weight of less than 10000 grams per mol.

The aminopolymer may comprise a plurality of repeat units that form the backbone. Any repeat unit or set of repeat units that would become apparent to one skilled in the art after reading the present disclosure may be used. Preferably, a majority of the repeat units have one or more of the hydroxyl functional groups tethered thereto, i.e., coupled directly to a carbon atom or carbon atoms thereof as a single hydroxyl group (—OH) or via a tethering group of the hydroxyl functional group with a hydroxyl group (—OH) at the end of the tethering group. Note that in some approaches, the repeat units may all have the same basic backbone chain length. In other approaches, some of the repeat units have a different basic backbone chain length than other repeat units in the same molecule, e.g., some repeat units have two backbone carbons and some have three backbone carbons. Moreover, for branched polymers, the branches may have the same or different numbers of repeat units.

Co-polymers containing multiple types of repeat units, each containing hydroxyl functional groups and zero, one, or more alkyl substituents, are also envisioned.

The hydroxyl functional groups may be any hydroxyl functional groups that would become apparent to one skilled in the art after reading the present disclosure.

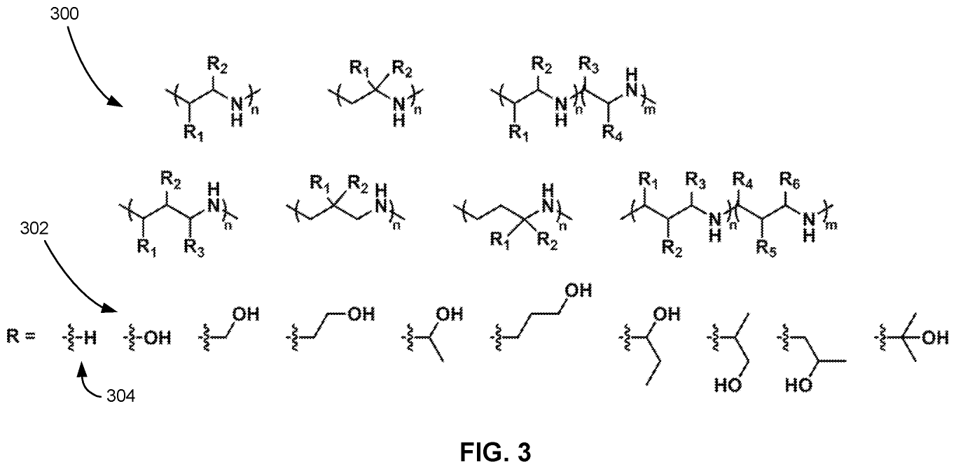

FIG. 3 depicts several illustrative repeat units 300 for polyethylenimines and polypropylenimines, as well as several illustrative hydroxyl functional groups 302 with various tethering structures that tether the hydroxyl group (—OH) to a carbon atom in the backbone, and hydrogen 304. A hydroxyl functional group 302, as described herein, may include a single hydroxyl group (—OH) or may include a tethering group with a hydroxyl group (—OH) on the tethering group. Note also that the tethering groups may be carbon chains, various isomers, etc.

In preferred approaches, the hydroxyl functionalities and/or hydrogen, generally denoted in the group “R” in the drawing, may be tethered in any combination to the carbon atoms as R1-R6 of the repeat units, so long as some, and preferably a majority, of the repeat units in a given backbone have at least one hydroxyl functionality tethered thereto.

As shown in the examples of FIG. 3, a hydroxyl functionality may be hydroxide, or may have an alkyl tether. Where present, the alkyl tether is preferably 1 to 4 carbon atoms in length including all isomers for a given size (e.g., n-propyl and isopropyl for 3 carbon atom chains; n-butyl, sec-butyl, iso-butyl, and t-butyl for 4 carbon chains). Alkyl tethers having 5 or more carbon atoms are also contemplated, with a maximum carbon count of about 10 per tether.

As shown in FIG. 3, in some cases, at least some of the repeat units may have only a single hydroxyl functional group, e.g., such as where R1 is hydrogen and R2 is a hydroxyl group in a repeat unit having an R1 and an R2.

In other cases, at least some of the repeat units have at least two hydroxyl functional groups, e.g., R1 and R2 are each, individually, hydroxyl groups. For example, as shown in some examples in FIG. 3, at least two of the hydroxyl groups are coupled to different carbon atoms of the associated repeat unit. In other approaches, at least two of the hydroxyl groups are coupled to the same carbon atom of the associated repeat unit. In various aspects, the hydroxyl functional groups of a single repeat unit may be of the same type, i.e., have the same chemical structure. In other approaches, none of the hydroxyl functional groups coupled to the associated repeat unit are of a same type, i.e., none of the hydroxyl functional groups on the particular repeat unit have the same chemical structure.

In some approaches, at least one hydroxyl functional group in each repeat unit is directly coupled to a carbon atom that is directly adjacent the amine in the repeat unit. Thus, for repeat units having a single hydroxyl function group coupled thereto, the single hydroxyl function group is preferably coupled to the carbon atom directly adjacent the amine. Likewise, where two hydroxyl functional group are coupled to the same carbon atom in the repeat unit, both hydroxyl functional groups are coupled to a carbon atom directly adjacent the amine. Note, however, that a hydroxyl functional group may be tethered to a carbon atom not directly adjacent to the amine by starting with a raw material that has the precursor group on the desired carbon, and proceeding according to the methodology presented herein.

In yet other approaches, at least some of the repeat units may have at least one different type of hydroxyl functional group coupled thereto relative to another of the repeat units immediately adjacent thereto. Said another way, one repeat unit may have one or more different hydroxyl functional groups than the repeat unit immediately next to the repeat unit along the polymer backbone.

The average number of repeat units in the molecules of the aminopolymer may be in a range of 5 to about 1500. Referring to FIG. 3, the number of repeat units is denoted as “n.” In preferred approaches, the average number of repeat units is about 10 to about 50.

In some approaches, the product includes a structure supporting the aminopolymer. Preferably, the structure is three dimensional and highly porous for increasing the surface area of the composite structure. For example, following synthesis of the aminopolymer with pendant hydroxyls, the aminopolymer may be supported on a high-surface-area material of known type using known methods established in the literature. See, e.g., U.S. patent Ser. No. 11/446,634 and U.S. Pub. No. 2022-0401917-A1, which are herein incorporated by reference for their teaching of supporting a polymer on a three-dimensional structure.

The resulting polymer-support composite may then be used for any suitable purpose, such as CO₂ capture and direct air capture. The capture and regeneration processes may follow conventional procedures currently used with conventional aminopolymers. Examples include steam stripping, temperature and/or vacuum swing desorption, and humidity swing desorption.

The invented materials described herein may be uniquely suited to remove the tradeoff between the protective effects of hydroxyl groups (improving the oxidative and thermal stability of the aminopolymer) and the CO₂ capture ability of primary and secondary amines, essentially obtaining the best of both worlds by introducing hydroxyl groups that improve the oxidative and thermal stability while not reducing, or potentially even increasing, the CO₂ capture ability of the amines.

Furthermore, the invented materials may be ideal for direct air carbon capture from cold weather climates due to their lower CO₂ binding enthalpy, allowing for more efficient CO₂ desorption/material regeneration at lower temperature with lower energy requirements.

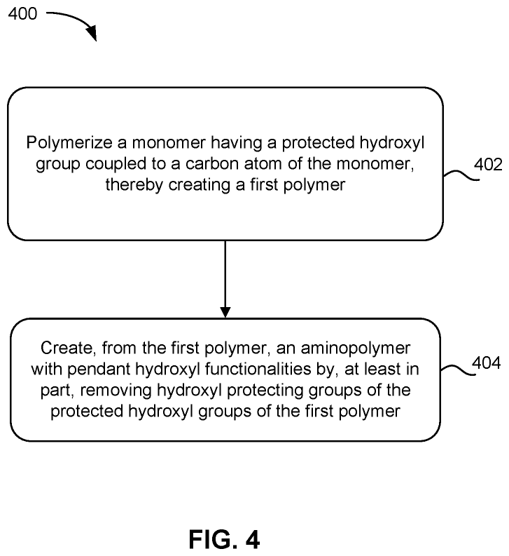

FIG. 4 shows a method 400 for forming an aminopolymer having hydroxyl functional groups coupled directly to carbon atoms in a backbone of the aminopolymer, in accordance with various aspects of the present invention. As an option, the present method 400 may be implemented to form materials and structures such as those described elsewhere herein and/or shown in the other FIGS. Of course, however, this method 400 and others presented herein are presented by way of example only. Further, the methods presented herein may be carried out in any desired environment. Moreover, more or less operations than those shown in FIG. 4 may be included in method 400, according to various embodiments. It should also be noted that any of the aforementioned features may be used in any of the embodiments described in accordance with the various methods.

In step 402, a monomer having a protected hydroxyl group coupled to a carbon atom of the monomer is polymerized, thereby creating a first polymer. The first polymer may be considered a protected aminopolymer, which may be branched or linear. As noted above, a single monomer may be polymerized, or co-monomers may be polymerized together. The monomer, having the protected hydroxyl group coupled to the carbon atom of the monomer, may be synthesized or purchased from a commercial source of such monomers.

The polymerizing of step 402 may include ring-opening polymerization, e.g., as described in various examples below. For example, aziridine (for branched PEI), azetidine (for branched PPI), oxazoline (for linear PEI), and/or oxazine (for linear PPI) monomers with chemically protected, tethered hydroxyl groups may be synthesized using established literature procedures. Additionally, enantiopure isomers may be used for synthesis of chiral aminopolymers.

In step 404, after polymerization, an aminopolymer with pendant hydroxyl functionalities is created from the first polymer by, at least in part, removing hydroxyl protecting groups of the protected hydroxyl groups. For example, removal of the hydroxyl protecting groups from aziridine/azetidine derived polymers (branched) results in formation of the aminopolymer. For oxazine/oxazoline derived polymers (linear), which have amide side chains, converting the first polymer to the aminopolymer may further include hydrolyzing the amide side chains.

A key aspect of the synthetic protocol of the method 400 of FIG. 4 is protection of the hydroxyl groups of the monomers prior to polymerization in order to prevent undesired side reactions.

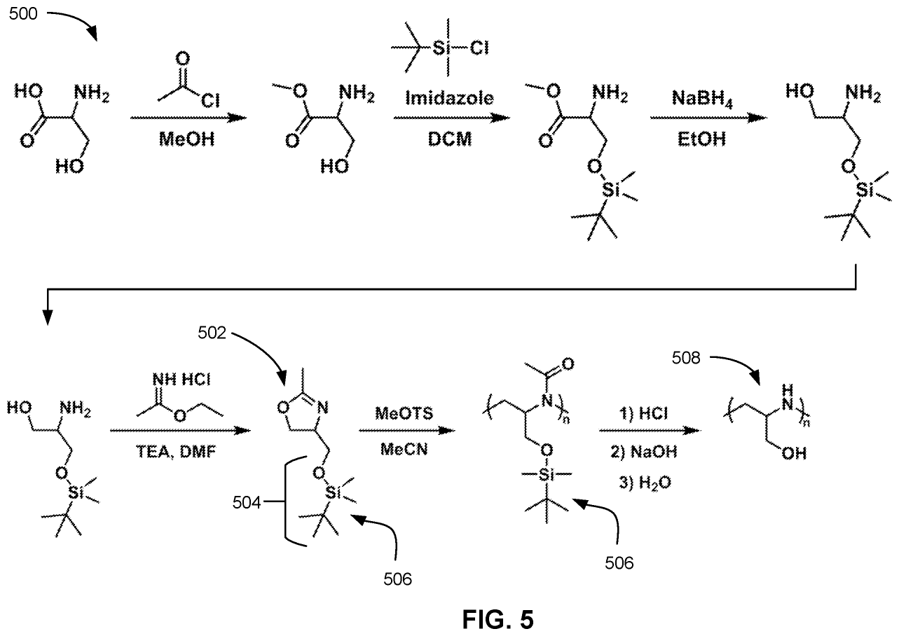

FIG. 5 depicts an illustrative method 500 for production of a linear PEI with pendant hydroxyls, in accordance with one approach. As an option, the present method 500 may be implemented to form materials such as those described elsewhere herein and/or shown in the other FIGS. Of course, however, this method 500 and others presented herein are presented by way of example only. Further, the methods presented herein may be carried out in any desired environment. Moreover, more or less operations than those shown in FIG. 5 may be included in method 500, according to various embodiments. It should also be noted that any of the aforementioned features may be used in any of the embodiments described in accordance with the various methods.

The illustrative method 500 for production of a linear PEI with pendant hydroxyls uses a protected hydroxyl group 504 having a tert-butyldimethylsilyl ether as the hydroxyl protecting group 506. However alternative hydroxyl protecting groups such as tert-butyldiphenylsilyl ethers may also be used.

The exemplary steps to obtain the monomer 502 are conventional, and may generally follow the exemplary sequence shown in FIG. 5.

In an alternate approach, the monomer 502 may be purchased instead of synthesized.

The monomer 502 is polymerized via cationic ring-opening polymerization, via a conventional ring-opening polymerization procedure. In the example shown, the ring-opening step is performed using methyltoluene sulfonate (MeOTS) and MeCN.

Following polymerization, in the final step shown, the backbone amides are hydrolyzed and the silyl ethers deprotected to yield the desired hydroxyl groups under acidic conditions (e.g., in the presence of HCl), and the resulting material is then neutralized (e.g., via NaOH and water) to produce the final aminopolymer 508 with pendant hydroxyls.

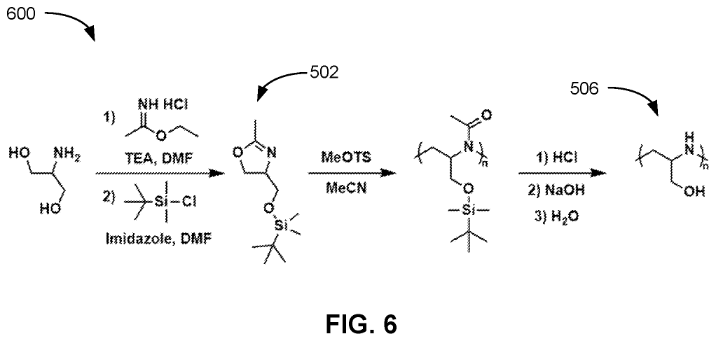

FIG. 6 depicts an illustrative method 600 for production of a linear PEI with pendant hydroxyls, in accordance with one approach. As an option, the present method 600 may be implemented to form materials such as those described elsewhere herein and/or shown in the other FIGS. Of course, however, this method 600 and others presented herein are presented by way of example only. Further, the methods presented herein may be carried out in any desired environment. Moreover, more or less operations than those shown in FIG. 6 may be included in method 600, according to various embodiments. It should also be noted that any of the aforementioned features may be used in any of the embodiments described in accordance with the various methods.

Referring to FIG. 6, the method 600 provides a shorter pathway to arrive at the same monomer 502 as used in method 500 of FIG. 5. Polymerization and formation of the hydroxyl groups on the polymer are the same in both methods 500, 600.

Similar chemistry techniques as those presented above may be used for synthesis of linear PPI with pendant hydroxyls, in a manner that would become apparent to one skilled in the art after reading the present disclosure.

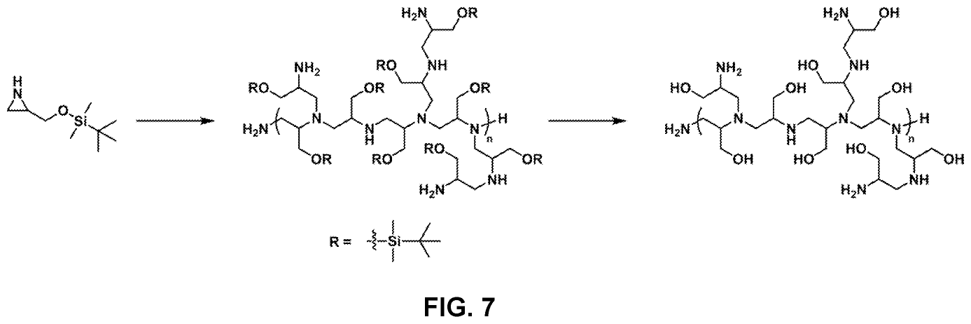

In yet other approaches, ring-opening chemistry may be used for synthesis of branched PEI or branched PPI with pendant hydroxyls from aziridines or azetidines, respectively, with pendant protected hydroxyl groups on the monomer, as in the example illustrated in FIG. 7.

Following synthesis of the aminopolymer with pendant hydroxyls, the aminopolymer may be supported on a high-surface-area material using known methods, such as dipping and drying, deposition, spincoating, etc.

In one approach, adding the aminopolymer to the support may include immersing a three-dimensional (3D) porous structure, e.g., ceramic support, in a mixture of the aminopolymer suspended in a volatile hydrophilic solvent (e.g., methanol, ethanol, etc.), and then drying the structure to remove the solvent by evaporation. In some approaches, the evaporation of the solvent may include applying heat and/or vacuum. In another approach, the aminopolymer may be added to the support material by a chemical functionalization of chemically binding the aminopolymer to the support material. Following removal of the solvent, aminopolymer remains within the pores of the support material.

In preferred approaches, the loading of aminopolymer is in a range of 20 to 70 wt. % relative to the total weight of the polymer-support composite product.

Illustrative support materials include metal meshes, ceramic support materials, porous silicas, porous aluminas, hollow fibers, porous organics, and hierarchical alumina monoliths, metal-organic frameworks, etc.

This polymer-support composite can then be used for its intended purpose, such as CO₂ capture, direct air capture, etc.

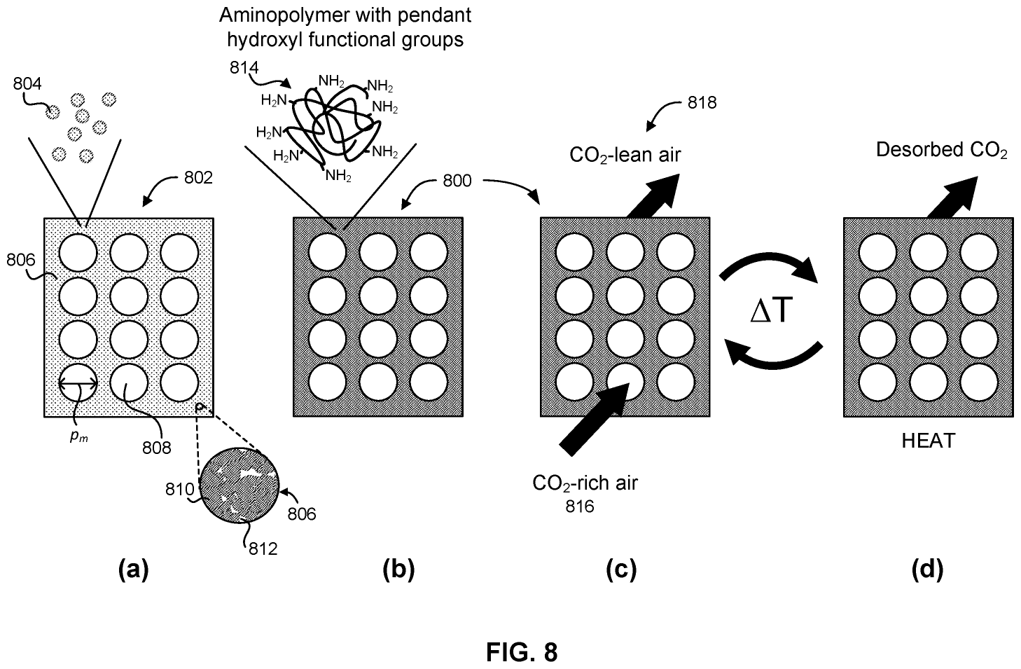

FIG. 8 illustrates, by way of example, a schematic diagram of the components of a product 800, in accordance with one embodiment. As an option, the present product 800 may be implemented in conjunction with features from any other inventive concept listed herein, such as those described with reference to the other FIGS. Of course, however, the product 800 and others presented herein may be used in various applications and/or in permutations which may or may not be specifically described in the illustrative embodiments listed herein. Further, the product 800 presented herein may be used in any desired environment.

As shown in part (a) of FIG. 8, the support is a 3D structure 802 constructed of any suitable material 806. In the example shown, the material 806 is ceramic. The 3D structure 802 may include features, inter-material pores 808 (where the pore is formed from a shape of the material), voids for the flow of the mixed gas stream through the porous product 800. In one approach the 3D structure 802 may be a monolithic form for low gas flow pressure drop.

Looking to the magnified view of a portion of ceramic material 806, the ceramic material 806 includes partially sintered ceramic particles 810 and an open cell structure with a plurality of intra-material pores 812. The open cell structure of the material may be defined as having interconnected pores, the pores are not sealed, the void space created within the pores allows the flow of gas, liquid, etc. to pass through the material, etc. The ceramic material 806 may be a mesoporous material having intra-material pores 812 with an average diameter in a range of about greater than 1 nanometer (nm) to about 50 nm. In some approaches, the intra-material pores 812 of the ceramic material 806 may be in a range of greater than 1 nm to less than 10 μm. In one approach, the intra-material pores 812 of the ceramic material 806 may be in a range of greater than 1 nm to about 1000 nm.

The ceramic material 806 of the 3D structure 802 may be formed from a powder 804 of ceramic material. The 3D structure 802, e.g., support structure, may be comprised of one or more of a variety of ceramic materials, including a metal oxide, a metalloid oxide, a metal carbide, a metalloid carbide, or a combination thereof. For example, in some approaches, the ceramic material may include SiO₂, Al₂O₃, TiO₂, MgO, SiC, etc.

The ceramic support may be synthesized via a variety of techniques utilizing preceramic polymers, ceramic powders, etc. including partial sintering, replica or sacrificial templating, direct foaming, bonding, aerogel formation, freeze-casting, or others. Additive manufacturing approaches including but not limited to direct ink writing, powder bed fusion, jetting, extrusion, or deposition may be used in the synthesis of the support material.

According to one embodiment, the 3D structure, e.g., bulk structure, includes a ceramic material comprising connections between particles thereby forming a porous material. The material of the ceramic support structure is porous, with multiple possible scales of hierarchical porosity. The material may have intra-material pores creating a small-scale, microporosity, or mesoporosity of intra-material pores having an average diameter in the range of greater than 1 to 1000 nanometers (nm) and/or a macroporosity of intra-material macropores having an average diameter in a range of greater than or equal to 10 micron (μm). In some approaches a material may have a number of length scales or pores, e.g., microporosity and mesoporosity, mesoporosity and microporosity, etc., all of which may be considered as intra-material pores. Moreover, in some approaches, a bulk structure may have feature sizes, inter-material pores 808, voids, etc. having an average diameter pₘ in a range of 100 μm to 1 millimeters (mm).

In one approach, the support material may be of monolithic form designed for optimal gas flow and low gas flow pressure drop. In other approaches, the support material may be a 3D structure with pre-defined geometry designed for optimal gas flow. In some approaches, the support material may be a 3D structure formed by methods such as use of a template, a mold, a cast, etc. The pores of the support material, e.g., intra-material pores, may be formed in part with a pore-forming agent, a binder, etc. as described herein.

In preferred approaches, the porosity of the 3D structure may be in a range of about 30% to 70%. In one approach, a specific surface area of the 3D structure may be in the range of 1 to 500 m²/g (meter squared per gram) and may be higher.

As illustrated in part (b) of FIG. 8, the 3D structure 802 of ceramic material 806 may be loaded, incorporated, etc. with one or more polyamines, as described herein, as gas sorbent additive(s). In one approach, the product 800 includes polyamine 814 primarily present in the intra-material pores 812 of the ceramic material 806 for sorption of a specific gas. In some approaches, the amount of amine-containing sorbent additive may be present in a range of greater than 20 wt. % to less than 70 wt. % of the combined weight of the aminopolymer and the ceramic material.

Part (c) illustrates how the product (support+aminopolymer) is contacted with a gas stream rich in a gas of interest to be selectively removed. For example, in one approach, an air stream that includes several gases and CO₂, e.g., a CO₂-rich air 816, may flow through the product 800. The sorbent selectively adsorbs some or all of the CO₂ gas from the gas stream, e.g., CO₂ from ambient air in DAC. The air stream now depleted substantially of CO₂, e.g., CO₂-lean air 818, continues to flow out of the 3D structure 802. Typically, the CO₂-lean air has a reduced CO₂ content compared to the incoming CO₂-rich air.

As shown in part (d), the incoming gas stream may be switched off, and the sorbent material may be regenerated by a process involving increased temperature, e.g., by application of a hot gas such as steam, joule heating, etc. In one approach, the heating may include application of a vacuum, e.g., temperature vacuum swing adsorption.

Once the sorbent ceramic product is regenerated and adsorbed gas removed from the system, the cycle may repeat, (as shown in part (c)), in which the sorbent additive is exposed to a mixed gas stream for adsorption of a selected gas. In some approaches of the cyclic adsorption-regeneration process, the adsorbed gas may not be completely removed from the sorbent during regeneration. For example only, the cycling CO₂ loading range may be selected to maximize long-term performance and throughput, and often the process may involve incomplete removal of the adsorbed CO₂.

### In Use:

Exemplary uses of the materials presented herein include: CO₂ capture from dilute sources such as atmosphere or more concentrated sources such as flue gas; CO₂ scrubbing from confined spaces (e.g. building, office, spacecraft, etc.); etc.

### Exemplary Embodiments

The synthetic route taken to achieve PEI analogues with pendant hydroxyl groups followed the standard procedure of using an oxazoline based monomer that undergoes a cationic ring-opening polymerization (CROP). The presence of a labile proton on the hydroxyl group necessitated the incorporation of a protecting group onto the hydroxyl, as it was susceptible to interfering with the polymerization mechanism.

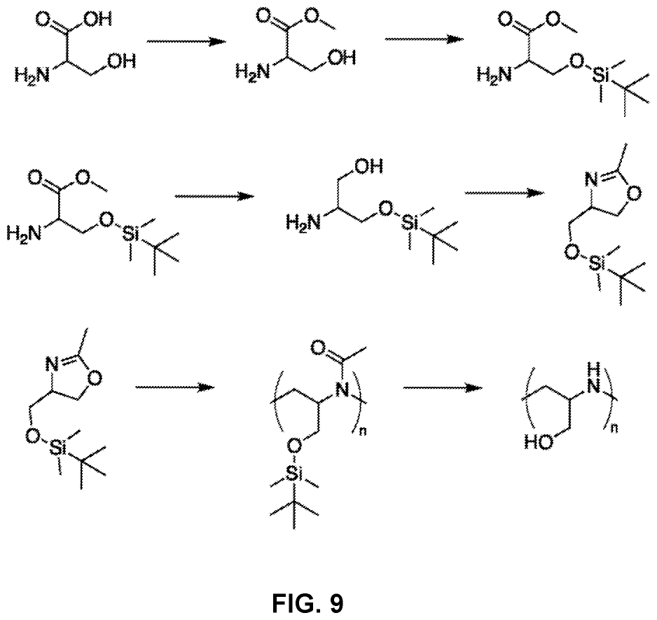

To avoid this, protecting groups were used. The group chosen for this route was a tert-butyldimethylsilyl moiety, which can be easily removed post-polymerization via acidic hydrolysis. An outline of one exemplary synthetic route is shown in FIG. 9.

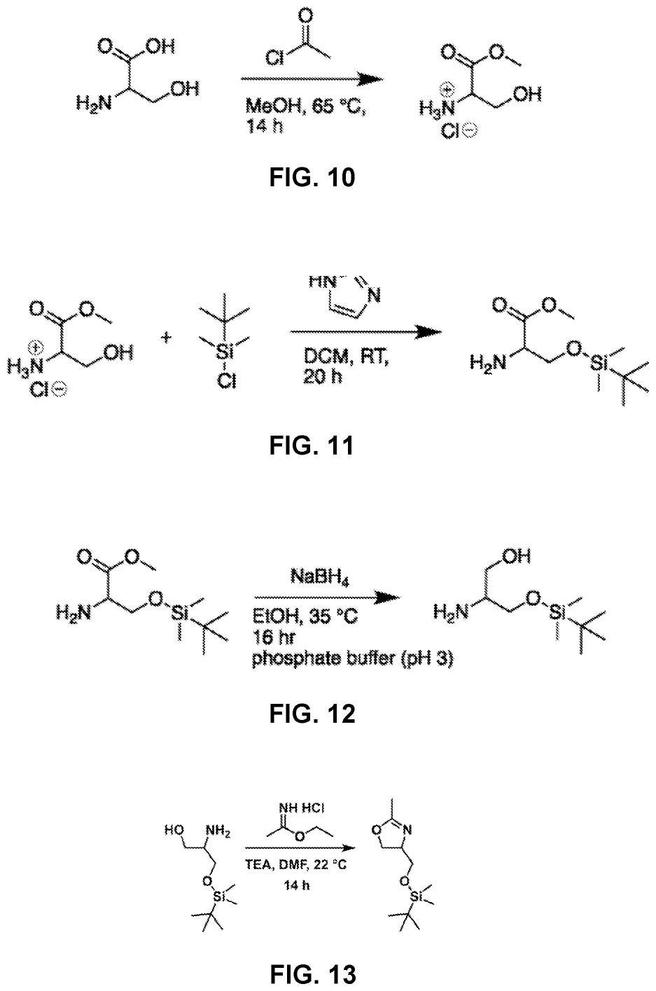

Synthesis began with the esterification of DL-serine. The esterification was achieved by adding three equivalents of acetyl chloride to one equivalent of DL-serine in anhydrous methanol, while keeping the reaction air and water free. The reaction was refluxed at 65° C. overnight, achieving a white powder with an overall yield of 95%. The synthesis of the hydrogen chloride salt of methyl serinate is shown in FIG. 10.

The protection of the hydroxyl group was accomplished by dissolving one equivalent of the DL-serine methyl ester in anhydrous dichloromethane, along with 1.4 equivalents of tert-butyldimethylsilylchloride and 6 equivalents of imidazole under air and water free conditions. The reaction was allowed to stir overnight, and after an extraction and vacuum distillation at 80° C., a yellow waxy solid was collected, with an overall yield of 57%. The synthesis of methyl O-(tert-butyldimethylsilyl) serinate is shown in FIG. 11.

Once the protection reaction was successful, the methyl ester was converted back to an alcohol, which was done in the following manner.

The distillate from the previous reaction was added to anhydrous methanol under air and water free conditions. To this was added 4.5 equivalents of sodium borohydride, and the reaction was left to stir at 35° C. overnight. After confirmation of reaction completion by 1H NMR, the reaction was quenched with a pH 3 phosphate buffer solution and left to stir overnight once again.

The quenched reaction was extracted three times with chloroform and vacuum distilled at 90° C. to yield the product. This is shown below in FIG. 12, which depicts synthesis of 2-amino-3-((tert-butyldimethylsilyl)oxy) propan-1-ol.

Cyclization of the amino alcohol to synthesize the protected oxazoline was accomplished by charging a dried 25 mL Schlenk flask with 1 equivalent of the silyl-protected amino alcohol, 1 equivalent of ethyl acetimidate hydrochloride, in anhydrous dichloromethane. 2 equivalents of triethylamine were added dropwise via syringe, and the reaction was left to stir at room temperature for 14 hours. Once complete conversion of the starting material was confirmed by 1H NMR, the reaction was quenched with DI water. The aqueous layer was extracted three times with dichloromethane and the combined organic phase was dried over magnesium sulfate, filtered, and dried using rotary evaporation to yield a viscous yellow oil with an overall yield of 83%. This reaction is shown in FIG. 13, which depicts synthesis of 4-(((tert-butyldimethylsilyl)oxy)methyl)-2-methyl-4,5-dihydrooxazole.

A combined cyclization and silyl protection of the amino alcohol was achieved in a one-pot reaction set up. A dried 500 mL 2-neck round bottom flask was charged with 1 equivalent of 2-amino-1,3-propanediol, 1 equivalent of ethyl acetimidate hydrochloride, in dimethylformamide (DMF). The reaction flask was cooled to 0° C. in an ice bath before the addition of 2 equivalents of triethylamine dropwise via syringe, and the reaction was left to stir at room temperature for 14 hours. After conversion of the starting material was confirmed by ¹H NMR, 4 equivalents of imidazole were added and the reaction was left to stir for 30 minutes, followed by addition of 2.5 equivalents of tert-butyldimethylsilyl chloride. The solution was left to stir for 72 hours, and reaction completion was verified by 1H NMR. The reaction was quenched with DI water, and the aqueous layer was extracted with chloroform. The combined organic layers were dried under vacuum, and subsequently purified by vacuum distillation.

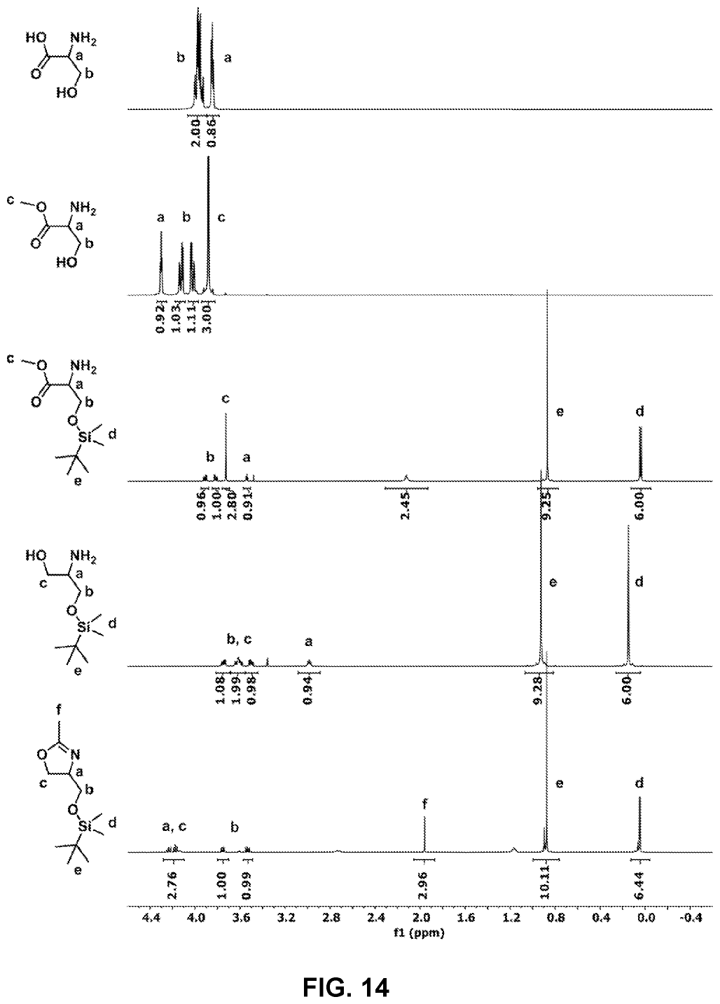

Characterization of synthesized materials was primarily accomplished using proton NMR. The 1H-NMR spectra for the purified products and the DL serine starting material is shown in FIG. 14, which depicts 1H-NMR spectra for relevant synthesized materials. In FIG. 14, the integrations are shown as well as peak assignments corresponding to the proton environments shown on the drawn structures.

The protected oxazoline described above may be polymerized, followed by the acid hydrolysis to deprotect the hydroxyl group. The final material may then be loaded into a solid oxide support via an impregnation method commonly used to prepare analogous materials for DAC.

We expect this novel form of functionalized PEI to demonstrate the increased stability against oxidative degradation and urea formation seen in 1,2-epoxybutane functionalized branched PEI (BPEI), while retaining a higher CO₂ working capacity. The hydroxyl groups are expected to behave comparably to those incorporated via epoxide functionalization due to them having relatively similar chemical environments of a hydroxyl moiety in proximity to the amine moiety. The primary difference is that the amino group will retain its primary or secondary amine characteristic, rather than being converted to a more substituted amine. Tertiary amines have been demonstrated to be less active towards CO₂ than primary and secondary amines, leading to the theory that this novel class of materials will be able to maintain high stability against oxidative degradation and urea formation while not having to sacrifice CO₂ working capacity.

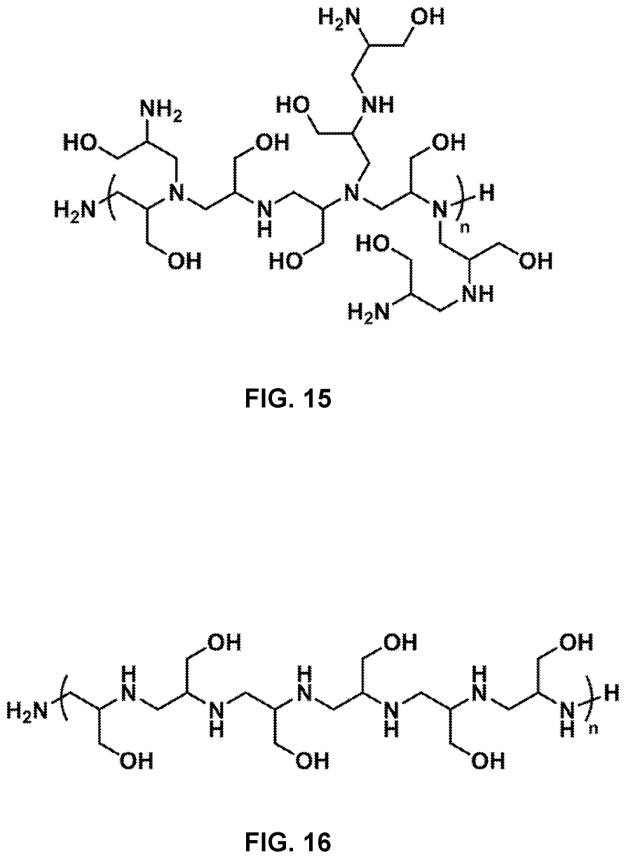

An illustrative branched aminopolymer with hydroxyl functional groups is depicted in FIG. 15. An illustrative linear aminopolymer with hydroxyl functional groups is depicted in FIG. 16.

The materials discussed herein are hypothesized to show a high CO₂ working capacity akin to linear PEI due to the high affinity of the secondary amines for adsorption, while also demonstrating high resistance against both oxidative degradation and urea formation. Without wishing to be bound by any particular theory, it is presently believed that more extensive hydrogen bonding capabilities and steric hindrance will be provided by this material, thereby having a significant stabilizing effect on the oxidative degradation mechanism by decreasing mobility and slowing peroxyl radical formation and hydrogen abstraction, while also suppressing urea formation.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept but should be defined only in accordance with the following claims and their equivalents.

1. A product, comprising:
an aminopolymer having hydroxyl functional groups coupled directly to carbon atoms in a backbone of the aminopolymer.

2. The product as recited in claim 1, wherein the aminopolymer is a linear polymer.

3. The product as recited in claim 1, wherein the aminopolymer is a branched polymer.

4. The product as recited in claim 1, wherein the aminopolymer comprises a plurality of repeat units that form the backbone, wherein at least some of the repeat units have one or more of the hydroxyl functional groups coupled directly to a carbon atom thereof.

5. The product as recited in claim 4, wherein at least some of the repeat units have a single hydroxyl functional group.

6. The product as recited in claim 4, wherein at least some of the repeat units have at least two hydroxyl functional groups.

7. The product as recited in claim 6, wherein at least two of the hydroxyl functional groups are coupled to different carbon atoms of the associated repeat unit.

8. The product as recited in claim 6, wherein at least two of the hydroxyl functional groups are coupled to the same carbon atom of the associated repeat unit.

9. The product as recited in claim 6, wherein none of the hydroxyl functional groups coupled to the associated repeat unit are of a same type.

10. The product as recited in claim 6, wherein at least two of the hydroxyl functional groups coupled to the associated repeat unit are of a same type.

11. The product as recited in claim 4, wherein at least some of the repeat units have at least one different type of hydroxyl functional group coupled thereto relative to another of the repeat units immediately adjacent thereto.

12. The product as recited in claim 4, wherein the number of repeat units in the backbone is in a range of 5 to about 500.

13. The product as recited in claim 1, wherein the hydroxyl functional groups are selected from the group consisting of:

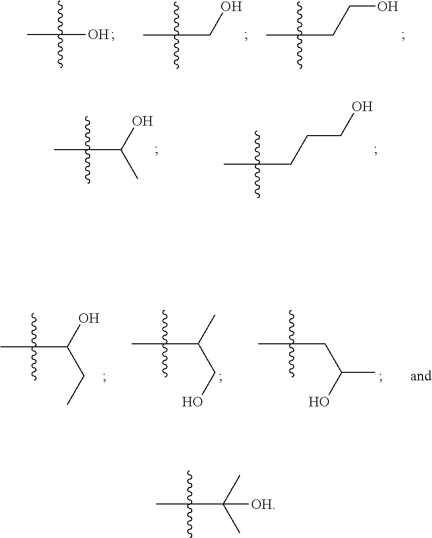

14. The product as recited in claim 1, comprising a three-dimensional structure supporting the aminopolymer.

15. The product as recited in claim 1, wherein the aminopolymer is selected from the group consisting of: poly(alkylamine), poly(ethylenimine), poly(propylenimine), poly(vinylamine), poly(allylamine), and a combination thereof.

16. The product as recited in claim 1, wherein the aminopolymer has an average molecular weight in a range of about 350 to about 100000 grams per mol.

17. A method of forming an aminopolymer having hydroxyl functional groups coupled directly to carbon atoms in a backbone of the aminopolymer, the method comprising:
polymerizing a monomer having a protected hydroxyl group coupled to a carbon atom of the monomer, thereby creating a first polymer; and
creating, from the first polymer, an aminopolymer with pendant hydroxyl functionalities by, at least in part, removing hydroxyl protecting groups of the protected hydroxyl groups of the first polymer.

18. The method as recited in claim 17, wherein the polymerizing includes ring-opening polymerization.

19. The method as recited in claim 17, wherein the first polymer has amide side chains, and wherein creating the aminopolymer further comprises hydrolyzing the amide side chains.

20. The method as recited in claim 17, wherein the aminopolymer is a branched polymer.
